(19) United States
(12) Patent Application Publication
(10) Pub. No.: US 2006/0066516 A1
(43) Pub. Date: Mar. 30, 2006

(54) Driving method of plasma display panel

(75) Inventors: Jeong-Chull Ahn, Suwon-si (KR); Eun-Young Jung, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/233,115

(22) Filed: Sep. 23, 2005

(30) Foreign Application Priority Data
Sep. 24, 2004 (KR) 10-2004-0077179

(51) Int. Cl. G09G 3/28

(52) U.S. Cl. 345/60

(57) ABSTRACT

A method of driving a PDP including, in a sustain discharge period, alternately applying a first sustain pulse and a second sustain pulse to a first electrode and a second electrode, respectively, and applying a pulse to a third electrode. The first sustain pulse and the second sustain pulse rise to a first voltage and fall to a tenth voltage, and a period in which a voltage of the first sustain pulse varies temporally overlaps a period in which a voltage of the second sustain pulse varies. The pulse applied to the third electrode is applied during the overlapping period.

### CROSS-REFERENCE TO RELATED PATENT APPLICATION

This application claims priority to and the benefit of Korean Patent Application No. 10-2004-0077179, filed on Sep. 24, 2004, which is hereby incorporated by reference for all purposes as if filly set forth herein.

### BACKGROUND OF THE INVENTION

1. Field of the Invention

The present invention relates to a driving method of a plasma display panel (PDP), and more particularly, to a PDP driving method that may improve discharge efficiency and brightness and prevent phosphor deterioration.

2. Discussion of the Background

Japanese Patent Publication No. 1999-120924 discloses a conventional plasma display panel (PDP), in which address electrode lines, lower and upper dielectric layers, scan electrode lines, sustain electrode lines, phosphor layers, barrier ribs, and a MgO protection layer are provided between the PDP's front and rear substrates.

The address electrode lines are formed in a predetermined pattern on a rear glass substrate, and the lower dielectric layer covers the address electrode lines. The barrier ribs are formed on the lower dielectric layer and in parallel to the address electrode lines. The barrier ribs partition discharge areas of display cells, thus preventing optical interference between display cells. The phosphor layers are formed between the barrier ribs on the lower dielectric layer, such that a red-emitting phosphor layer, a green-emitting phosphor layer, and a blue-emitting phosphor layer are sequentially arranged along each address electrode line.

The sustain electrode lines and the scan electrode lines are formed in a predetermined pattern on a rear surface of the front substrate, and they are arranged to orthogonally intersect the address electrode lines. Each intersection of an address electrode line and a scan and sustain electrode pair corresponds to a display cell. Each sustain and scan electrode line may include a transparent electrode line, which may be made of a transparent conductive material such as indium tin oxide (ITO), and a metal electrode (bus electrode) for increasing conductivity. The upper dielectric layer covers the sustain electrode lines and the scan electrode lines. A protection layer, such as a MgO layer, may be formed covering the upper dielectric layer to protect the PDP from a strong electric field. Each discharge space is filled with plasma forming gas.

FIG. 1 is a timing diagram showing driving signals for driving a conventional PDP. Referring to FIG. 1, a sub field SF may include a reset period PR, an address period PA, and a sustain-discharge period PS. The driving signals are respectively applied to the address electrode lines A₁, A₂, . . . , Aₘ, sustain electrode lines X₁, X₂, . . . , Xₙ, and scan electrode lines Y₁, Y₂, . . . ,Yₙ.

In the reset period PR, a reset pulse is applied to all scan electrode lines Y₁, Y₂, . . . ,Yₙ, to perform reset discharge, thereby initializing wall charge states in all discharge cells.

The reset period PR is performed for all discharge cells before the address period PA to provide substantially uniform wall charges in all discharge cells. As FIG. 1 shows, a ground voltage V_{g}, a sustain discharge voltage Vₛ, and a rising ramp signal rising from the sustain discharge voltage Vₛ to a maximum voltage Vₛₑₜ+Vₛ are sequentially applied to the scan electrode lines Y₁, Y₂, . . . ,Yₙ. The maximum voltage Vₛₑₜ+Vₛ is then dropped to the sustain discharge voltage Vₛ, and a falling ramp signal falling from the sustain discharge voltage Vₛ to a minimum voltage V_{nf} is applied to the scan electrode lines Y₁, Y₂, . . . , Yₙ. During the reset period PR, the ground voltage V_{g} is applied to the address electrode lines A₁, A₂, . . . , Aₘ, and a bias voltage V_{b} is applied to the sustain electrode lines X₁, X₂, . . . , Xₙ during the falling ramp signal.

In the following address period PA, in order to select cells to be turned on, while applying the bias voltage V_{b} to the sustain electrode lines X₁, X₂, . . . , Xₙ and a high scan voltage V_{sch} to unselected scan electrode lines Y₁, Y₂, . . . , Yₙ, a scanning pulse of a low scan voltage V_{scl} may be sequentially applied to select the respective scan electrode lines Y₁, Y₂, . . . , Yₙ. A display data signal of an address voltage Vₐ is applied to the address electrode lines A₁, A₂, . . . , Aₘ, thereby selecting cells to which the scanning pulse and the display data signal are applied by performing an address discharge.

Then, in the sustain-discharge period PS, a sustain pulse is alternately applied to the sustain electrode lines X₁, X₂, . . . , Xₙ and the scan electrode lines Y₁, Y₂, . . . , Yₙ to perform a sustain discharge on the selected cells. The sustain pulse rises to the sustain discharge voltage Vₛ and falls to the ground voltage V_{g}. Referring to FIG. 2, a sustain pulse applied to a scan electrode Y rises between a time tₐ and a time t_{b} to the sustain discharge voltage Vₛ. The sustain discharge voltage Vₛ is maintained between the time t_{b} and a time t_{c}, and then the sustain pulse falls between the time t_{c} and a time t_{d} to the ground voltage V_{g}. The ground voltage V_{g} is then maintained between the time td and a time t_{g}. A sustain pulse applied to a sustain electrode X has a ground voltage between the time tₐ and the time t_{d}, and then rises between the time t_{d} and a time tₑ to the sustain discharge voltage Vₛ. The sustain discharge voltage Vₛ is maintained between the time tₑ and a time t_{f}, and then the sustain pulse falls between the time t_{f} and the time t_{g} to the ground voltage V_{g}. As FIG. 2 shows, the sustain pulse of the sustain discharge voltage Vₛ may be alternately applied to the scan electrode Y and the sustain electrode X in such a manner that a sustain discharge pulse is not simultaneously applied to the scan electrode Y and the sustain electrode X.

The wall charges accumulated in the selected discharge cells and the applied sustain discharge voltage Vₛ generate the sustain discharge. The plasma forming gas generates plasma in the discharge cells on which the sustain-discharge is performed, thereby generating ultraviolet radiation that excites phosphors of the discharge cells, thus emitting light.

In the conventional 3-electrode surface discharge type PDP as described above, scan electrodes Y and sustain electrodes X are arranged in parallel on the rear surface of the front substrate. Due to such an arrangement, when the driving signals shown in FIG. 1 and FIG. 2 are applied to drive the PDP, during sustain discharge, although ion particles are accelerated by an electric field generated by a voltage applied to the scan electrodes Y and the sustain electrodes X and collide with discharge gas to generate a discharge, since the path of the ion particles is limited, the particles may have limited movement. Accordingly, a probability of ion particles colliding with the discharge gas may be low, and the discharge may concentrate in a small part of each discharge cell, which decreases the PDP's discharge efficiency and brightness.

### SUMMARY OF THE INVENTION

The present invention provides a PDP driving method that may improve discharge efficiency and brightness and prevent phosphor deterioration, by temporally overlapping and applying sustain pulses to sustain electrodes and scan electrodes and applying a pulse to address electrodes, during a sustain-discharge period.

Additional features of the invention will be set forth in the description which follows, and in part will be apparent from the description, or may be learned by practice of the invention.

The present invention discloses a method of driving a PDP including, in a sustain discharge period, alternately applying a first sustain pulse and a second sustain pulse to a first electrode and a second electrode, respectively, and applying a pulse to a third electrode. The first sustain pulse and the second sustain pulse rise to a first voltage and fall to a tenth voltage, and a period in which a voltage of the first sustain pulse varies temporally overlaps a period in which a voltage of the second sustain pulse varies. The pulse applied to the third electrode is applied during the overlapping period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a timing diagram showing driving signals for driving a conventional PDP.

FIG. 2 is a detailed timing diagram showing a sustain discharge period of FIG. 1.

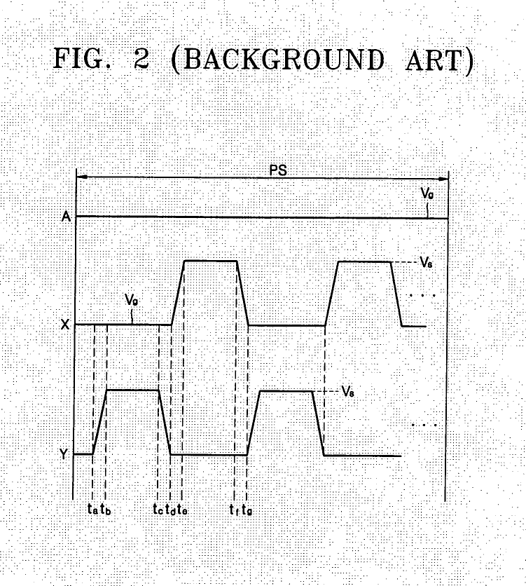

FIG. 3 is a partially exploded perspective view showing a PDP as an example of a PDP that may be driven using a driving method according to an embodiment of the present invention.

FIG. 4 is a sectional view along line II-II of FIG. 3.

FIG. 5 schematically illustrates an electrode arrangement of the PDP of FIG. 3.

FIG. 6 is a block diagram showing a driving apparatus for performing a method of driving the PDP of FIG. 3.

FIG. 7 is a view for explaining an address-display separation driving method for Y electrode lines, as a method of driving the PDP of FIG. 3, according to an embodiment of the present invention.

FIG. 8 is a timing diagram for explaining driving signals according to an embodiment of the present invention.

FIG. 9 is a timing diagram for explaining driving signals applied during a sustain discharge period of FIG. 8 according to an embodiment of the present invention.

FIG. 10A and FIG. 10B show potential distribution in a discharge cell when applying the driving signals of FIG. 1 and FIG. 8 to the discharge cell, respectively.

FIG. 11A and FIG. 11B show electron density in a discharge cell when applying the driving signals of FIG. 1 and FIG. 8 to the discharge cell, respectively.

FIG. 12A and FIG. 12B show 147 nm ultraviolet radiation distribution in a discharge cell when applying the driving signals of FIG. 1 and FIG. 8 to the discharge cell, respectively.

FIG. 13A and FIG. 13B show 173 nm ultraviolet radiation distribution in a discharge cell when applying the driving signals of FIG. 1 and FIG. 8 to the discharge cell, respectively.

### DETAILED DESCRIPTION OF THE ILLUSTRATED EMBODIMENTS

Hereinafter, embodiments of the present invention will be described in detail with reference to the appended drawings.

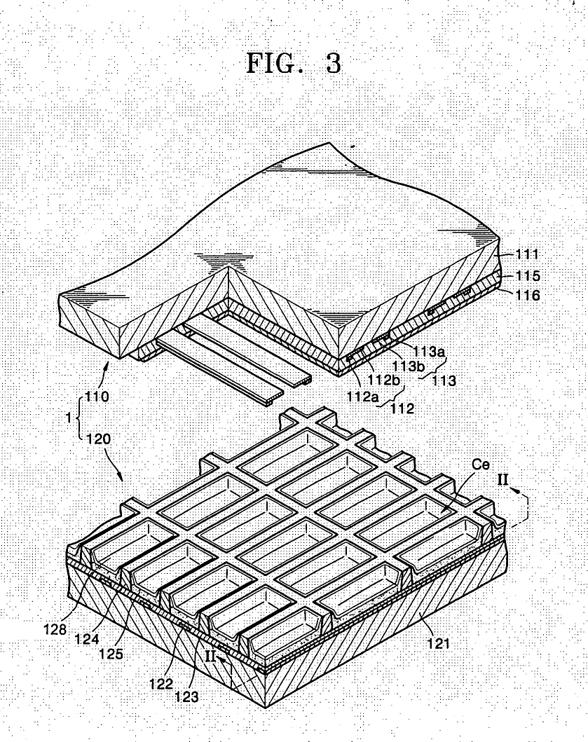

FIG. 3 is a partially exploded perspective view showing a plasma display panel (PDP) 1 as an example of a PDP that may be driven using a driving method according to exemplary embodiments of the present invention.

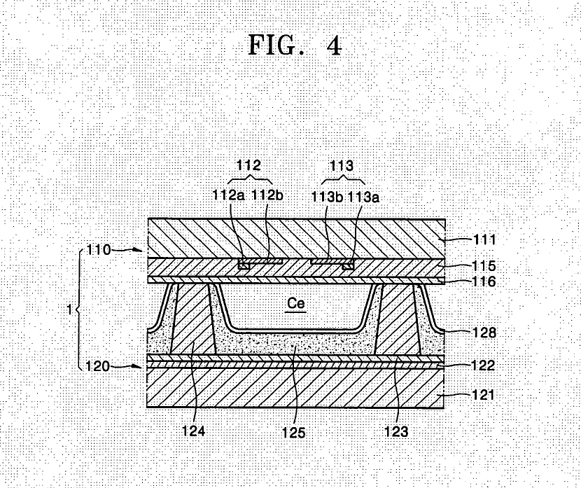

FIG. 4 is a sectional view along line II-II of FIG. 3.

Referring to FIG. 3 and FIG. 4, the PDP 1 includes a front panel 110 and a rear panel 120. The front panel 110 includes a front substrate 111, and the rear panel 120 includes a rear substrate 121. The PDP 1 includes barrier ribs 124, which are disposed between the front substrate 111 and the rear substrate 121 and partition discharge cells Ce. Discharge occurs in each discharge cell Ce to emit light to form an image.

A front dielectric layer 115 covers the scan electrode lines 112 and sustain electrode lines 113, which are described below. Each scan electrode line 112 includes a bus electrode 112a, which may be made of a metal material for increasing conductivity, and a transparent electrode 112b, which may be made of a transparent conductive material such as ITO. Likewise, each sustain electrode line 113 includes a bus electrode 113a and a transparent electrode 113b. The scan electrode lines 112 and the sustain electrode lines 113 extend in a direction in which the discharge cells Ce are arranged.

A front protection film 116 may be formed to cover and protect the front dielectric layer 115.

Address electrode lines 122 are formed on the rear substrate 121, and they are arranged to orthogonally intersect the scan electrode lines 112 and the sustain electrode lines 113. The rear dielectric layer 123 covers the address electrode lines 122.

Barrier ribs 124 are formed on the rear dielectric layer 123 to partition the discharge cells Ce, and a phosphor layer 125 is formed in spaces partitioned by the barrier ribs 124. A rear protection layer 128, which protects the phosphor layer 125, may be formed covering the phosphor layer 125.

The front panel 110 and the rear panel 120 may be sealed together by a coupling material, such as frit (not shown). If a vacuum is formed inside the discharge cells Ce, the front panel 110 and the rear panel 120 may be coupled by a pressure caused by the vacuum. A gas mixture consisting of one or more of Ne, He, and Ar, containing 10% Xe gas, is filled in the discharge cells Ce.

The front substrate 111 and the rear substrate 121 are generally made of glass. The front substrate 111 is made of a material with high light-transmittance, while the rear substrate 121 may be made of various materials that do not have high light-transmittance. For example, the rear substrate 121 may be made of highly reflective materials or materials that are capable of reducing reactive power.

In order to improve the PDP's brightness, a reflective layer (not shown) may be formed on an upper surface of the rear substrate 121 or on an upper surface of the rear dielectric layer 123, or the rear dielectric layer 123 may contain a light-reflective material, so that visible light emitted from the phosphor layer 125 may reflect towards the front substrate 111.

The transparent electrodes 112b and 11 3b of the scan electrode lines 112 and the sustain electrode lines 113, which are disposed on the rear surface of the front substrate 111, transmit visible light emitted from the phosphor layer 125. Accordingly, the transparent electrodes 112b and 113b are made of a material with high light-transmittance, such as ITO, SnO₂, or ZnO. The address electrode lines 122 may be made of various conductive materials, such as Ag, Cu, and Cr, regardless of the material's light-transmittance. A front protection film 116, which covers the front dielectric layer 115, protects the front dielectric layer 115 and emits secondary electrons for participation in a discharge.

The barrier ribs 124, which are disposed between the front substrate 111 and the rear substrate 121, partition the discharge cells Ce with the front substrate 111 and the rear substrate 121. In FIG. 3, the barrier ribs 124 partition the discharge cells Ce in a matrix form. However, the barrier ribs 124 may have various forms, such as a honeycomb form and a delta form. Referring to FIG. 4, the cross section of each discharge cell Ce is rectangular, however, the cross section of the discharge cell Ce may be a polygon such as a triangle and a pentagon, a circle, an ellipse, etc.

The barrier ribs 124 are formed on the upper surface of the rear dielectric layer 123, and they may be made of a material such as glass containing an element such as Pb, B, Si, Al, and 0. The barrier ribs 124 may further contain filler, such as ZrO₂, TiO₂, and Al₂O₃, and pigment such as Cr, Cu, Co, Fe, and TiO₂, as necessary. The barrier ribs 124 form spaces in which the phosphor layer 125 will be formed, and they support the front panel 110 and the rear panel 120 when discharge gas filled between the front panel 110 and the rear panel 120 has a low pressure, for example, a pressure below 0.5 atm, that is when the space between the front panel 110 and the rear panel 120 is nearly a vacuum. The barrier ribs 124 form the discharge spaces of the discharge cells Ce and prevent crosstalk between the discharge cells Ce. Either a red-emitting phosphor layer, a green-emitting phosphor layer, or a blue-emitting phosphor layer is formed in each space partitioned by the barrier ribs 124. That is, the phosphor layer 125 is partitioned by the barrier ribs 124.

The phosphor layer 125 is formed by applying a phosphor paste, in which a red-emitting phosphor, a green-emitting phosphor, or a blue-emitting phosphor is mixed with a solvent and a binder, on the exposed upper surface of the rear dielectric layer 123 and the lateral portions of the barrier ribs 124, and drying and heating the phosphor paste. The red-emitting phosphor may be made of Y(V,P)O₄:Eu, etc., the green-emitting phosphor may be made of ZnSiO₄:Mn, YBO₃:Tb, etc., and the blue-emitting phosphor may be made of BAM:Eu, etc.

The rear protection film 128 may be made of a material such as MgO, and it may cover the phosphor layer 125. The rear protection film 128 protects phosphors from damage due to collision with charged particles when discharge occurs in the discharge cells Ce, and it emits secondary electrons that participate in a discharge.

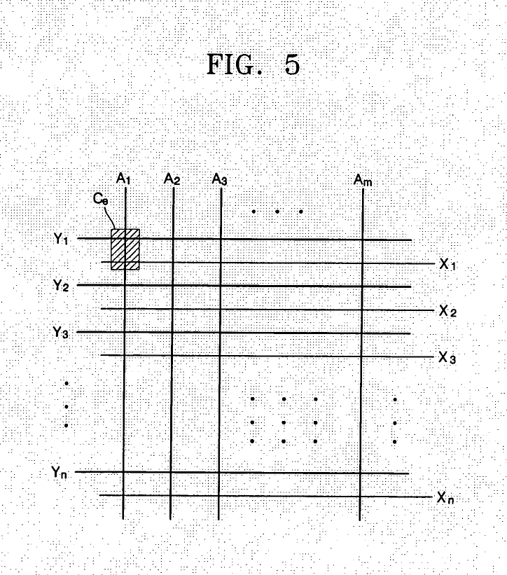

FIG. 5 schematically illustrates an electrode arrangement of the PDP 1 of FIG. 3.

Referring to FIG. 3, FIG. 4 and FIG. 5, scan electrode lines Y₁, Y₂, . . . , Yₙ and sustain electrode lines X₁, X₂, . . . , Xₙ are arranged in parallel, and they are covered by the front dielectric layer 115. Address electrode lines A₁, A₂, . . . , Aₘare disposed to orthogonally intersect the scan electrode lines Y₁, Y₂, . . . , Yₙ and the sustain electrode lines X₁, X₂, . . . , Xₙ. Discharge cells Ce are formed at an intersection of an address electrode and a scan and sustain electrode pair.

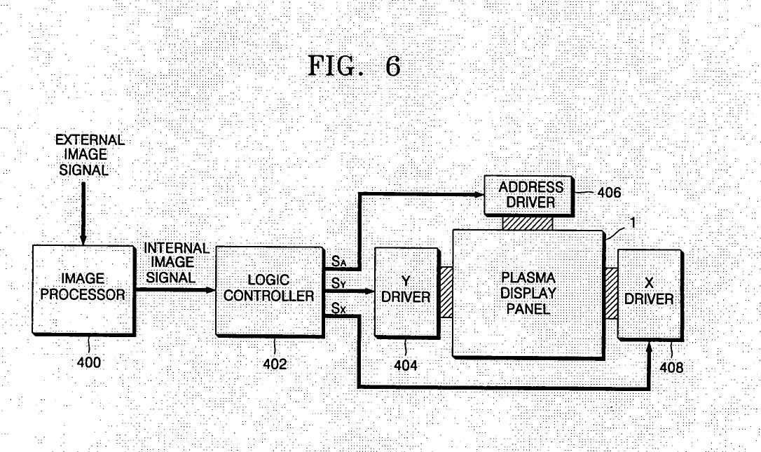

FIG. 6 is a block diagram showing an exemplary driving apparatus for performing a method of driving the PDP 1 of FIG. 3.

Referring to FIG. 5 and FIG. 6, the PDP driving apparatus may include an image processor 400, a logic controller 402, a Y driver 404, an address driver 406, and an X driver 408.

The image processor 400 receives an image signal, such as a PC signal, a DVD signal, a video signal, or a TV signal and converts, as necessary, the image signal into a digital signal, image-processes the digital signal, and then outputs the image-processed signal as an internal image signal. The internal image signal may include red (R), green (G), and blue (B) image data, a clock signal, and a horizontal and vertical sync signal, each with 8 bits.

The logic controller 402 receives the internal image signal from the image processor 400, performs gamma-correction, automatic power control (APC), etc. on the internal image signal, and then outputs an address driving control signal S_{A}, a Y driving control signal S_{Y}, and an X driving control signal S_{X}.

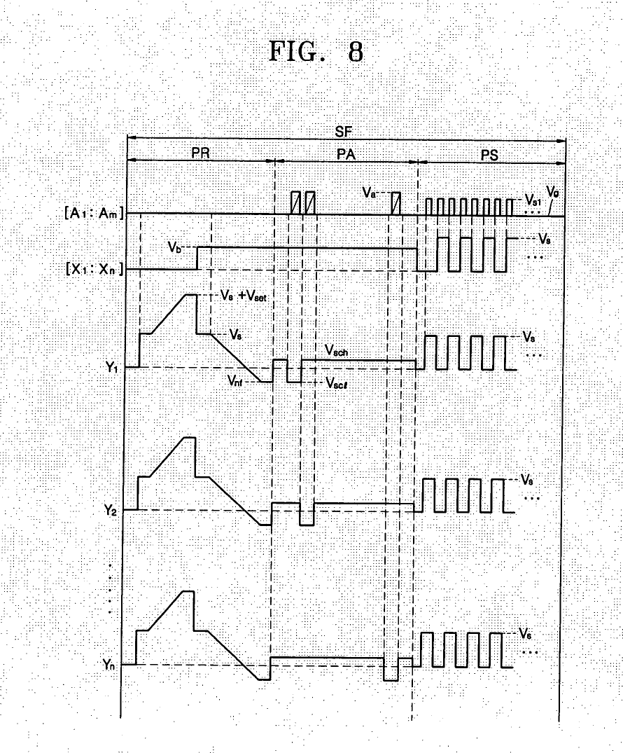

The Y driver 404 receives the Y driving control signal S_{Y} from the logic controller 402 and applies driving signals to the scan electrode lines Y₁, Y₂, . . . , Yₙ. For example, the Y driver 404 applies an erase pulse with an erase voltage to perform initialization discharge during a reset period (PR of FIG. 8). During an address period (PA of FIG. 8), the Y driver 404 applies a scan signal varying between a high scan voltage (V_{sch} of FIG. 8) of a positive polarity and a low scan voltage (V_{scl} of FIG. 8) of a negative polarity sequentially applied along the vertical direction of the PDP 1. During a sustain discharge period (PS of FIG. 8), the Y driver 404 applies a sustain pulse varying between a sustain discharge voltage (Vₛ of FIG. 8) of a positive polarity and a ground voltage (V_{g} of FIG. 8).

The address driver 406 receives an address driving control signal SA from the logic controller 402, and outputs a display data signal of an address voltage (Vₐ of FIG. 8) to address electrode lines corresponding to cells to be turned on during the address period (PA of FIG. 8). During the sustain discharge period (PS of FIG. 8), the address driver 406 applies a pulse (Vₛ₁ of FIG. 8) to the address electrode lines. The voltage Vₛₗ of the pulse may be less than or equal to the address voltage (Vₐ of FIG. 8).

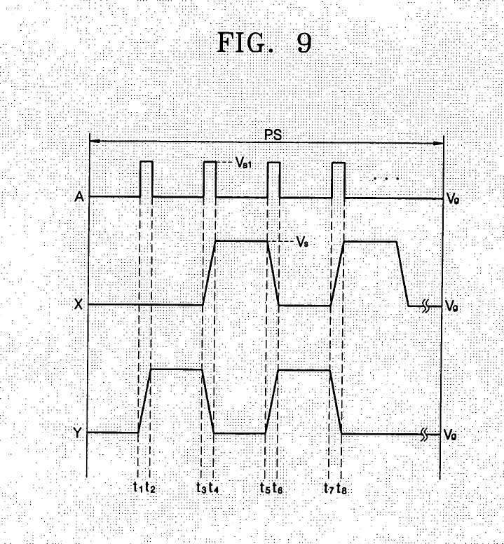

The X driver 408 receives the X driving control signal S_{X} from the logic controller 402, applies a pulse of a bias voltage (V_{b} of FIG. 8) to the sustain electrode lines X₁, X₂, . . . , Xₙ during a reset period (PR of FIG. 8) and an address period (PA of FIG. 8), and applies a sustain pulse varying between a sustain discharge voltage (Vₛ of FIG. 8) of a positive polarity and a ground voltage (V_{g} of FIG. 8) to the sustain electrode lines X₁, X₂, . . . , Xₙ during a sustain discharge period (PS of FIG. 9).

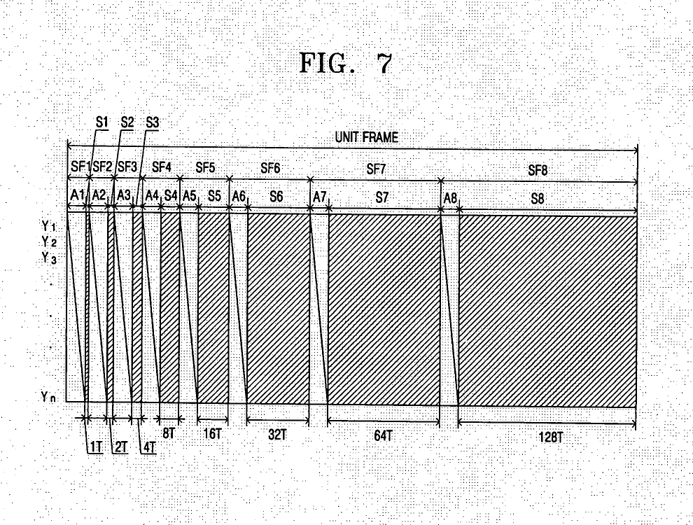

FIG. 7 is a view for explaining an address-display separation driving method for Y electrode lines, as a method of driving the PDP 1 of FIG. 3, according to an embodiment of the present invention.

Referring to FIG. 5 and FIG. 7, a unit frame may be divided into a predetermined number of subfields, for example, eight subfields SF1 through SF8, to implement time division gray scale display. The subfields SF1 through SF8 may be respectively divided into reset periods (not shown), address periods A1 through A8, and sustain-discharge periods S1 through S8.

During the address periods A1 through A8, a display data signal is sequentially applied to the respective address electrode lines A₁, A₂, . . . , Aₘ and corresponding scan pulses are sequentially applied to the respective scan electrode lines Y₁, Y₂, . . . , Yₙ.

During the sustain-discharge periods S1 through S8, a sustain pulse is alternately applied to the scan electrode lines Y₁, Y₂, . . ., Yₙ and the sustain electrode lines X₁, X₂, . . . , Xₙ, so that sustain discharge occurs in discharge cells in which wall charges are formed during the address periods A1 through A8 (i.e. selected cells).

The PDP's brightness is proportional to the number of sustain discharge pulses applied during the sustain discharge periods in a unit frame. If a frame forming one image is displayed by 8 sub-fields in 256 gray-scales, different numbers (e.g. 1, 2, 4, 8, 16, 32, 64, and 128) of sustain pulses may be sequentially assigned to the respective sub-fields. In this case, to obtain the brightness of a 133 gray-scale level, a cell may be addressed and sustain-discharged during the periods of a first sub-field SF1, a third sub-field SF3, and an eighth sub-field SF8.

The number of sustain-discharges (sustain-discharge pulses) assigned to each sub-field depends on a weight of the sub-field based on APC. Alternatively, the number of sustain-discharges assigned to each sub-field may be set considering gamma characteristics or panel characteristics. For example, it is possible to decrease a gray-scale level assigned to a fourth sub-field SF4 from 8 to 6 and increase a gray-scale level assigned to a sixth sub-field SF6 from 32 to 34. Also, the number of sub-fields forming one frame may vary according to a design rule.

FIG. 8 is a timing diagram for explaining driving signals according to an embodiment of the present invention.

FIG. 9 is a timing diagram for explaining driving signals applied during a sustain discharge period of FIG. 8 according to an embodiment of the present invention.

Referring to FIG. 8 and FIG. 9, a subfield SF may include a reset period PR, an address period PA, and a sustain discharge period PS.

During the reset period PR, a ground voltage V_{g} is first applied to scan electrode lines Y₁, . . . , Yₙ. Next, a sustain discharge voltage Vₛ as a first voltage is applied and then a rising ramp signal rising to a maximum rising voltage Vₛₑₜ+Vₛ as a third voltage increased by a second voltage Vₛₑₜ from the first voltage Vₛ is applied to the scan electrode lines Y₁, . . . , Yₙ. Since a rising ramp signal with a gradual slope is applied, a weak discharge is, generated, thereby accumulating negative charges near the scan electrode lines Y₁, . . . , Yₙ.

Then, the third voltage Vₛ+Vₛₑₜ sharply falls to the first voltage Vₛ and a falling ramp signal falling to a minimum falling voltage V_{nf} as a fourth voltage is applied to the scan electrode lines Y₁, . . . , Yₙ. Since the falling ramp signal has a gradual slope, a weak discharge is generated due to the application of the falling ramp signal, and a portion of the negative charges accumulated near the scan electrode lines Y₁, . . . , Yₙ is discharged due to the weak discharge. As a result, a sufficient amount of negative charges allowing an address discharge may remain near the scan electrode lines Y₁, . . . , Yₙ. A bias voltage V_{b} as a fifth voltage is applied to the sustain electrode lines X₁, . . . , Xₙ when the falling ramp signal is applied to the scan electrode lines Y₁, . . . , Yₙ. A ground voltage V_{g} is applied to the address electrode lines A₁, A₂, . . . , Aₘ during the reset period PR.

Next, during the address period PA, to select cells to be turned on, a high scan voltage V_{sch} as a sixth voltage is first applied to all the scan electrode lines Y₁, . . . , Yₙ and then a scanning pulse with a low scan voltage V_{scl} as a seventh voltage may be sequentially applied to the respective scan electrode lines Y₁, . . . , Yₙ. At this time, a display data signal with an address voltage Vₐ as an eighth voltage is applied to the address electrode lines A₁, A₂, . . . , Aₘ in synchronization with the scanning pulse. The fifth voltage V_{b} is continuously applied to the sustain electrode lines X₁, . . . , X_{f}. Address discharge is generated by the eighth voltage Vₐ, the seventh voltage V_{scl}, a wall voltage created by negative charges accumulated near the scan electrodes Y₁, . . . , Yₙ, and a wall voltage created by positive charges accumulated near the address electrodes A₁, . . . , Aₘ. The address discharge accumulates positive charges near the scan electrodes Y₁, . . . , Yₙ and negative charges near the sustain electrodes X₁, . . . , Xₙ.

During the sustain discharge period PS, first and second sustain pulses, each rising to the first voltage Vₛ and falling to the ground voltage V_{g}, are alternately applied to the scan electrode lines Y₁, . . . , Yₙ and the sustain electrode lines X₁, . . . , Xₙ, respectively. The first sustain pulse overlaps the second sustain pulse during periods in which the voltages of the first and second sustain pulses vary. During the periods in which the voltages of the first and second sustain pulses vary, a pulse is applied to the address electrode lines A₁, . . . , Aₘ.

The pulse is provided to the address electrode lines to improve discharge efficiency during sustain discharge. The pulse may be applied during at least a portion of a period in which the voltage of the first or second sustain pulse varies. Specifically, the pulse applied to the address electrode lines may be applied while the first or second sustain pulse rises to the first voltage Vₛ from the ground voltage V_{g}. Also, the pulse may be applied when the first or second sustain pulse begins to rise. The pulse width of the pulse may be smaller than half of that of the first or second sustain pulse. Also, the pulse has a ninth voltage Vₛ₁. The ninth voltage Vₛ₁ may be smaller than the eighth voltage Vₐ, or it may equal the eighth voltage Vₐ in order to reduce the number of supply voltage levels that need to be output from a power source (not shown).

As shown in FIG. 8, the first sustain pulse temporally overlaps the second sustain pulse while the voltages of the first and second sustain pulses vary.

Referring to FIG. 9, during a period PS, between a time t₁ and a time t₂, a first sustain pulse rising to a first voltage Vₛ is applied to the scan electrode lines Y₁, . . . , Yₙ. At this time, a second sustain pulse of a ground voltage V_{g} is applied to the sustain electrode lines X₁, . . . , Xₙ. During a period between the time t₂ and a time t₃, the first sustain pulse is maintained at the first voltage Vₛ, and the second sustain pulse remains at the ground voltage V_{g}. During a period between the time t₃ and a time t₄, the first sustain pulse falls to the ground voltage V_{g}, and the second sustain pulse rises to the first voltage Vₛ. Then, during a period between the time t₄ and a time t₅, the first sustain pulse remains at the ground voltage V_{g}, and the second sustain pulse remains at the first voltage Vₛ. Then, during a period between the time t₅ and a time t₆, the first sustain pulse rises to the first voltage Vₛ, and the second sustain pulse falls to the ground voltage V_{g}. During a period between the time t₆ and a time t₇, the first sustain pulse is maintained at the first voltage Vₛ, and the second sustain pulse remains at the ground voltage V_{g}. During a period between the time t₇ and a time t₈, the first sustain pulse falls to the ground voltage V_{g}, and the second sustain pulse rises to the first voltage Vₛ. The first and second sustain pulses are respectively applied to the scan electrode lines Y₁, . . . , Yₙ and the sustain electrodes lines X₁, . . . , Xₙ, as described above. The rising and falling slopes of the first and second sustain pulses are generally used to charge and collect energy. During the sustain-discharge period PS, the periods in which the first sustain pulse rises or falls temporally overlap the periods in which the second sustain pulse rises or falls. Referring to FIG. 9, the first sustain pulse temporally overlaps the second sustain pulse during the periods between t₃ and t₄, between t₅ and t₆, and between t₇ and t₈. However, the present invention is not limited to this. As the overlapping time lengthens, a sustain discharge period by the first sustain pulse and the second sustain pulse can decrease. In other words, as a discharge frequency increases, space charges may be efficiently used when performing sustain discharge, which improves light-emitting efficiency and brightness.

In view of charges in each discharge cell, if the first sustain pulse has the positive first voltage Vₛ, sustain discharge is performed by the positive first voltage Vₛ applied to the scan electrodes Y₁, . . . , Yₙ, a ground voltage V_{g} applied to the sustain electrodes X₁, . . . , Xₙ, a wall voltage created by positive charges accumulated near the scan electrodes Y₁, . . . , Yₙ, and a wall voltage created by negative charges accumulated near the sustain electrodes X₁, . . . , Xₙ. As a result, negative charges accumulate near the scan electrodes Y₁, . . . , Yₙ, and positive charges accumulate near the sustain electrodes X₁, . . . , Xₙ. Next, if the second sustain pulse has the positive first voltage Vₛ, sustain discharge is performed by the first voltage Vₛ applied to the sustain electrodes X₁, . . . , Xₙ, the ground voltage V_{g} applied to the scan electrodes Y₁, . . . , Yₙ a positive wall voltage created by positive charges accumulated near the sustain electrodes X₁, . . . , Xₙ, and a wall voltage created by negative charges accumulated near the scan electrodes Y₁, . . . , Yₙ. As a result, positive charges accumulate near the scan electrodes Y₁, . . . , Yₙ, and negative charges accumulate near the sustain electrodes X₁, . . . , Xₙ.

By temporally overlapping the first sustain pulse and the second sustain pulse, a discharge frequency increases, which may cause more frequent ion sputtering of phosphor layers formed over the address electrodes, resulting in deterioration of the phosphor layers.

To solve this problem and enhance brightness through the improvement in the discharge volume, according to an embodiment of the present invention, a pulse is applied to the address electrodes A when the first and second sustain pulses overlap.

The pulse may be applied to the address electrodes A during at least a portion of a period in which the first or second sustain pulse rises or falls. More preferably, the pulse is applied during a period in which the first or second sustain pulse rises to the first voltage Vₛ. Most preferably, the pulse is applied when the first or second sustain pulse begins to rise.

In FIG. 9, the pulse is applied to the address electrodes A during periods (between t₁ and t₂ and between t₅ and t₆) in which the first sustain pulse rises and during periods (between t₃ and t₄ and between t₇ and t₈) in which the second sustain pulses rises. However, the present invention is not limited to this. For example, the pulse can be applied during only the periods in which the first sustain pulse rises or during only the periods in which the second sustain pulse rises.

Further, in FIG. 9, the pulse is applied to the address electrodes A when the first or second sustain pulse begins to rise. However, the pulse may be applied at any time while the voltage of the first or second sustain pulse varies.

The pulse applied to the address electrodes A has a positive voltage Vₛ₁. While the first sustain pulse rises, a portion of negative charges in discharge cells moving to scan electrodes Y moves to the address electrodes A. While the second sustain pulse rises, a portion of negative charges in discharge cells moving to the sustain electrodes X moves to the address electrodes A. Because the pulse Vₛ₁ has a positive polarity, positive charges in the discharge cells may not move near the address electrodes A. Therefore, it is possible to prevent phosphor deterioration due to ion sputtering and increase the life-span of the PDP. The ability to prevent phosphor deterioration and improve life-span is more pronounced with overlapping waveforms with a high discharge frequency. Since the negative charges (electrons) in the discharge cells move to the address electrodes A, the discharge volume expands toward the address electrodes A, as well as between the scan electrodes Y and the sustain electrodes X, which results in improving brightness.

In order to prevent a large amount of negative charges from inflowing from the scan electrodes Y, the pulse width of the applied pulse to the address electrodes A may be half that or less than that of the first or second sustain pulse. The ninth voltage Vₛ₁ may be smaller than the eighth voltage Vₐ. However, considering the increase in manufacturing costs associated with increasing the number of supply voltage levels to be output from a power source, the ninth voltage Vₛ₁ may equal the eighth voltage Vₐ.

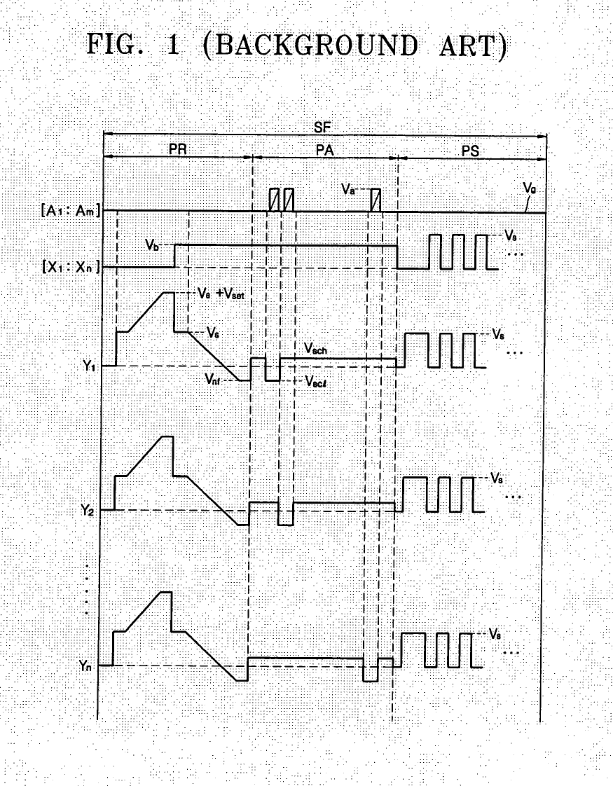

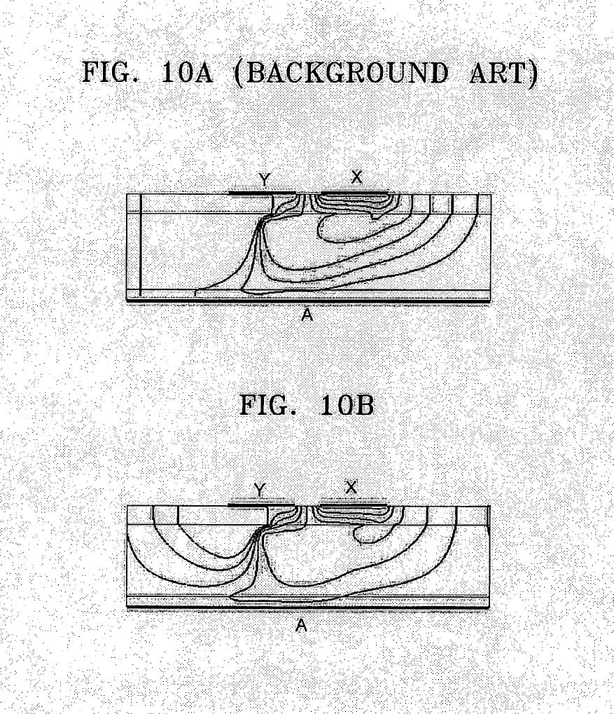

FIG. 10A and FIG. 10B show potential distribution in a discharge cell when applying the driving signals of FIG. 1 and FIG. 8 to the discharge cell, respectively.

FIG. 10A shows a case where the conventional driving signals of FIG. 1 are used. In this case, potentials are distributed substantially near a sustain electrode X when sustain discharge is performed. FIG. 10B shows a case where sustain pulses, which temporally overlap in predetermined periods, are applied to a scan electrode Y and a sustain electrode Y and a pulse is applied to an address electrode A, according to the driving method of the present invention. In this case, potentials are substantially uniformly distributed near the scan electrode Y as well as near the sustain electrode X.

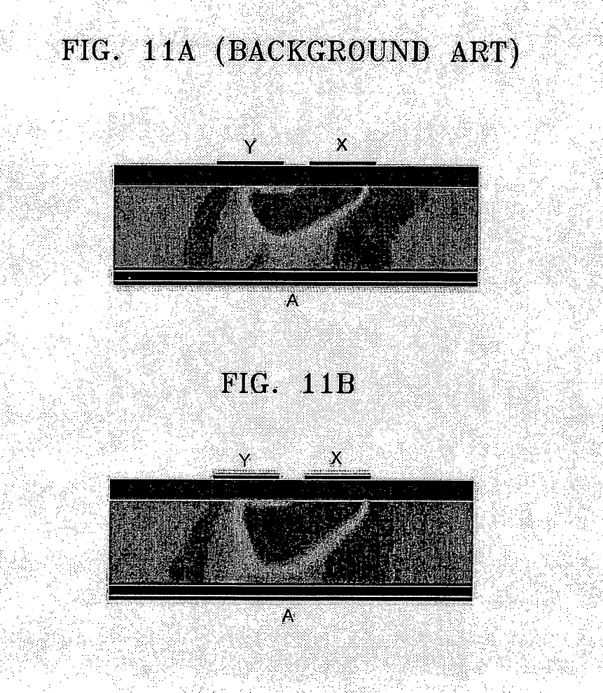

FIG. 11A and FIG. 11B show electron density in a discharge cell when applying the driving signals of FIG. 1 and FIG. 8 to the discharge cell, respectively.

Comparing FIG. 11A with FIG. 11B, the region with high electron density in the discharge cell shown in FIG. 11B is wider than the region with high electron density in the discharge cell shown in FIG. 11A. Consequently, by applying the pulse to the address electrodes A, the movement of electrons is activated and the collision of priming particles occurs more frequently, thereby improving discharge efficiency.

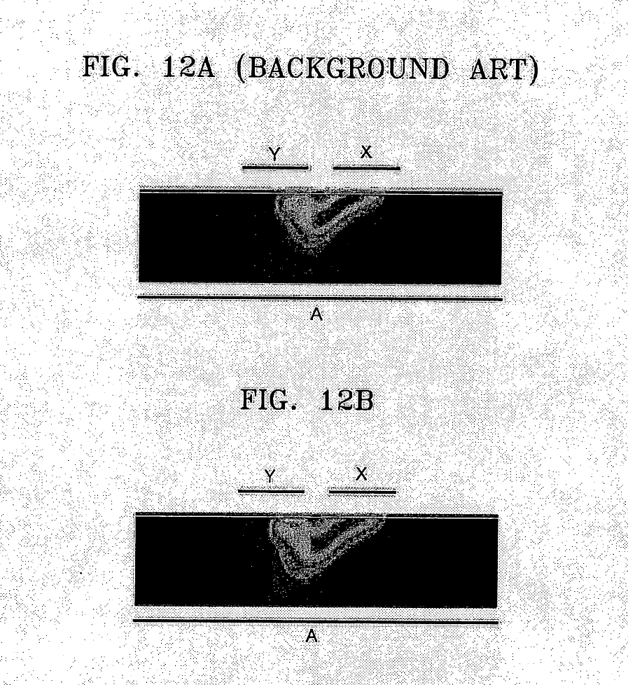

FIG. 12A and FIG. 12B show 147 nm ultraviolet radiation distribution in a discharge cell when applying the driving signals of FIG. 1 and FIG. 8 to the discharge cell, respectively.

Comparing FIG. 12A with FIG. 12B, the 147 nm ultraviolet radiation is distributed to barrier ribs over a rear substrate as well as near a front substrate in the discharge cell shown in FIG. 12B.

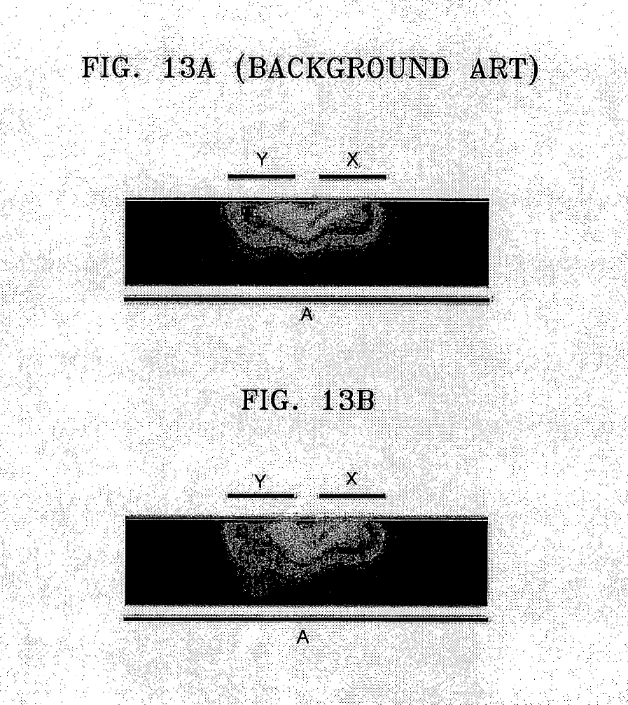

FIG. 13A and FIG. 13B show 173 nm ultraviolet radiation distribution in a discharge cell when applying the driving signals of FIG. 1 and FIG. 8 to the discharge cell, respectively.

Comparing FIG. 13A with FIG. 13B, 173 nm ultraviolet radiation is distributed to barrier ribs over a rear substrate as well as near a front substrate in the discharge cell shown in FIG. 13B.

As described above, according to exemplary embodiments of the present invention, the following effects may be obtained.

First, by temporally overlapping and applying first and second sustain pulses respectively to scan electrodes and sustain electrodes and applying a pulse to address electrodes, potential distribution in each discharge cell may become more uniform, the region with high electron density in each discharge cell may widen, and the distribution region of 173 nm ultraviolet radiation in each discharge cell may also widen.

Second, by increasing a discharge volume, it is possible to improve discharge efficiency and brightness.

Third, by applying a positive pulse voltage to address electrodes, it is possible to reduce ion sputtering of phosphors caused by charged particles of discharge gas, to prevent phosphor deterioration, and to increase the life-span of the PDP.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of driving a plasma display panel (PDP), the PDP including a first electrode and a second electrode arranged substantially in parallel with each other, and a third electrode arranged substantially orthogonally to the first electrode and the second electrode, the PDP being driven in a reset period, an address period, and a sustain discharge period, the method comprising:
in the sustain discharge period,
alternately applying a first sustain pulse and a second sustain pulse to the first electrode and the second electrode, respectively; and
applying a pulse to the third electrode,
wherein the first sustain pulse and the second sustain pulse rise to a first voltage and fall to a tenth voltage, and a period in which a voltage of the first sustain pulse varies temporally overlaps a period in which a voltage of the second sustain pulse varies, and
wherein the pulse applied to the third electrode is applied during the temporally overlapped period.

2. The method of claim 1, wherein the pulse applied to the third electrode is applied during at least one of a portion of a period in which the voltage of the first sustain pulse varies and a portion of a period in which the voltage of the second sustain pulse varies.

3. The method of claim 2, wherein the pulse applied to the third electrode is applied during a period in which the first sustain pulse or the second sustain pulse rises to the first voltage from the tenth voltage.

4. The method of claim 3, wherein the pulse applied to the third electrode is applied when the first sustain pulse or the second sustain pulse begins to rise.

5. The method of claim 4, wherein a pulse width of the pulse applied to the third electrode is no more than half of a pulse width of the first sustain pulse or the second sustain pulse.

6. The method of claim 5, further comprising:
in the reset period,
applying to the first electrode a rising ramp signal rising from the first voltage to a third voltage increased by a second voltage from the first voltage and then applying a falling ramp signal falling from the first voltage to a fourth voltage;
applying a fifth voltage to the second electrode when the falling ramp signal is applied to the first electode; and
applying the tenth voltage to the third electrode.

7. The method of claim 6, further comprising:
in the address period,
while applying a sixth voltage to first electrodes, a scanning pulse with a seventh voltage is sequentially applied to the first electrodes, a display data signal with an eighth voltage is s applied to third electrodes in response to the scanning pulse, and the fifth voltage is continuously applied to second electrodes.

8. The method of claim 7, wherein the pulse applied to the third electrode in the sustain discharge period has a ninth voltage, and a magnitude of the ninth voltage is smaller than a magnitude of the eighth voltage.

9. The method of claim 7, wherein the pulse applied to the third electrode in the sustain discharge period has a ninth voltage, and a magnitude of the ninth voltage is equal to a magnitude of the eighth voltage.

10. The method of claim 7, wherein the tenth voltage is a ground voltage.

11. A method of driving a plasma display panel (PDP), the PDP including a first electrode and a second electrode arranged substantially in parallel with each other, and a third electrode arranged substantially orthogonally to the first electrode and the second electrode, the PDP being driven in a reset period, an address period, and a sustain discharge period, the method comprising:
in the sustain discharge period,
alternately applying a first sustain pulse to the first electrode and a second sustain pulse to the second electrode; and
applying a pulse to the third electrode,
wherein the first sustain pulse and the second sustain pulse rise to a first voltage and fall to a second voltage, and a period in which a voltage of the first sustain pulse varies temporally overlaps a period in which a voltage of the second sustain pulse varies.

12. The method of claim 11, wherein the pulse applied to the third electrode is applied during the temporally overlapped period.

13. The method of claim 12, wherein:
the first sustain pulse rises to the first voltage at a first slope and falls to the second voltage at a second slope, and
the second sustain pulse rises to the first voltage at a third slope and falls to the second voltage at a fourth slope.

14. The method of claim 13, wherein the first slope, the second slope, the third slope, and the fourth slope are all equal to each other.

15. The method of claim 12, wherein during the temporally overlapped period, a sum of the voltage applied to the first electrode and the voltage applied to the second electrode remains substantially equal to the first voltage.

16. A method of driving a plasma display panel (PDP), the PDP including a first electrode and a second electrode arranged substantially in parallel with each other, and a third electrode arranged substantially orthogonally to the first electrode and the second electrode, the PDP being driven in a reset period, an address period, and a sustain discharge period, the method comprising:
in the sustain discharge period,
alternately applying a first sustain pulse to the first electrode and a second sustain pulse to the second electrode; and
applying a pulse to the third electrode,
wherein the first sustain pulse rises to a first voltage and falls to a second voltage and the second sustain pulse rises to a third voltage and falls to a fourth voltage, and a period in which a voltage of the first sustain pulse varies temporally overlaps a period in which a voltage of the second sustain pulse varies.

17. The method of claim 16, wherein the pulse applied to the third electrode is applied during the temporally overlapped period.

18. The method of claim 17, wherein the first voltage and the third voltage are equal to each other, and the second voltage and the fourth voltage are equal to each other.

19. The method of claim 18, wherein the second voltage is a ground voltage.

20. The method of claim 17, wherein a potential difference between the first voltage and the fourth voltage generates a sustain discharge in a discharge cell that was addressed during the address period.
